(19) United States
(12) Patent Application Publication
(10) Pub. No.: US 2008/0133249 A1
(43) Pub. Date: Jun. 5, 2008

(54) AUDIO DATA TRANSMITTING DEVICE AND AUDIO DATA RECEIVING DEVICE

(76) Inventors: Kohei HASHIGUCHI, Kyoto (JP); Takayuki MATSUI, Osaka (JP); Kiyotaka IWAMOTO, Kyoto (JP); Eiichi MORIYAMA, Osaka (JP)

Correspondence Address: MCDERMOTT WILL & EMERY LLP, 600 13TH STREET, NW, WASHINGTON, DC, 20005-3096, US

(21) Appl. No.: 11/947,388

(22) Filed: Nov. 29, 2007

(30) Foreign Application Priority Data
Nov. 30, 2006 (JP) 2006-323402
Nov. 5, 2007 (JP) 2007-286912

(51) Int. Cl. G10L 21/00

(52) U.S. Cl. 704/500; 704/E21.001

(57) ABSTRACT

When an unreceivable audio sampling frequency is transmitted from an audio data transmitting device or received at an audio data receiving device, frequency changing processing is executed inside an HDMI LSI of the transmitter side or the receiver side to change the unreceivable audio sampling frequency to a frequency that can be received at the audio data receiving device based on EDID information retained in the audio data receiving device, and mute processing of the audio information is executed to prevent generation of strange sounds.

### BACKGROUND OF THE INVENTION

1. Field of the Invention

The present invention relates to a method and a system for transmitting video data and audio information (audio clock information packet and audio data), and to a transmitting device and a receiving device used in such system.

2. Description of the Related Art

Recently, for transmitting video data and audio information (audio clock information packet and audio data) from a video/audio data transmitting device such as a DVD player to a video/audio data receiving device such as a TV receiver set, data communications are used in accordance with HDMI (High-Definition Multimedia Interface). With the HDMI, authentication of apparatuses defined in HDCP (High-bandwidth Digital Content Protection system) is carried out for protecting copyrights of video data and audio information.

The HDMI is a transmission interface for a new generation of multimedia AV equipment, and it is used for transmitting signals in many kinds of digital AV home electrical appliances such as digital TVs, DVD recorders, set-top boxes, and other digital AV products. The HDMI is a transmission system that is improved from a conventional transmission system with which video and audio are separated, and it is a multimedia interface for transmitting video and audio simultaneously by integrated signals. The HDMI can transmit highly packed digital signals effectively through employing an uncompressed type high-resolution digital data transmission, and its maximum transmission speed reaches 5 G bits/s. Further, the HDMI can output digital video data such as DVI as output video signals. Further, it is capable of transmitting audio signals of eight channels simultaneously. The HDMI is a multimedia terminal/interface with such excellent features, and is an indispensable item for digital products.

To be more specific, the HDCP is a standard for protecting transmission of contents between a video/audio data transmitting device that encrypts and transmits contents and a video/audio data receiving device that receives and decrypts the contents. With the HDCP, the video/audio data transmitting device performs authentication of the video/audio data receiving device by using an authentication protocol, and transmits encrypted contents. Authentication of the apparatuses in the HDCP is performed through DDC (Display Data Channel) communication that is pursuant to IIC (Inter-Integrated Circuit).

EDID (Extended Display Identification data) information serving as information on an apparatus on the other side in the HDMI is obtained through the DDC communication. EDID information contains apparatus information regarding types of signals that can be processed through the HDMI, information regarding resolution of panels as well as information regarding pixel clocks, horizontal effective periods, vertical effective periods, maximum output audio sampling frequency, and the like. By performing the DDC communication, information of the connected apparatus on the other side can be imported. Details of EDID information are depicted in E-EDID Implementation Guide (VESA standard).

FIG. 1 shows a state where a video/audio data transmitting device and a video/audio data receiving device are connected via a cable that conforms to the HDMI. The video/audio data transmitting device Tx comprises a DVD drive or a CD drive (referred to as a drive hereinafter) 13, an HDMI LSI 15, and a B/E LSI (back/End) 11. The B/E LSI 11 comprises a CPU. The CPU performs control when transmitting audio/video data obtained from a recording medium (DVD, CD, etc) via the drive 13 to the HDMI LSI 15 and a connected apparatus on the other side (audio data receiving device Rx). The audio data transmitting device Tx and the audio data receiving device Rx are connected via an HDMI cable. Reference numeral 20 is an AV AMP 20 for reproducing audio data that is outputted from the audio data transmitting device Tx. The AV AMP 20 and the audio data transmitting device Tx are connected via an optical cable.

The audio data transmitting device Tx outputs the audio data obtained from the recording medium by the B/E LSI 11 to the HDMI LSI 15 and the AV AMP 20 (the audio line connected apparatus on the other side) by using an audio line such as I2s or SPDIF (optical signals of IEC60958 standard). In the video/audio data transmitting device Tx, the HDMI LSI 15 sets the audio data and audio clock information packet, and transmits the set data/packet to the audio data receiving device Rx via the HDMI cable. The audio data receiving device Rx obtains detailed information regarding the audio information that is being received from the contents set in the received packet. In this packet, N as frequency dividing information and information called CTS that is time information are set. High-definition Multimedia Interface Specification Version 1.3 depicts details of the audio data and audio clock information. In this technical document, “Audio Sample Packet” corresponds to audio data, and “Audio Clock Regeneration Packet” corresponds to audio clock information packet.

It is possible to calculate audio sampling frequency Fs of the audio from the frequency dividing information N and the time information CTS. The calculating equation thereof can be expressed as (1).

128*Fs=Ft*N/CTS (1)

It is assumed here that the frequency dividing information N and the time information CTS are generated by the B/E LSI 11 when the video/audio data transmitting device Tx transmits the audio data. “Ft” in the calculating equation indicates a TMDS clock.

After the frequency dividing information N and the time information CTS (which is the information regarding the data sampling performed when the video/audio data transmitting device Tx generates the audio data) is generated by the B/E LSI 11, the information N and CTS along with the audio data is transmitted from the video/audio data transmitting device Tx towards the video/audio data receiving device Rx. The video/audio data receiving device Rx judges the audio sampling frequency Fs from the received frequency dividing information N and the time information CTS. For example, there is assumed a case where the TMDS clock Ft is 25.2 MHz and the time information CTS is 25200. When the audio data is outputted with the audio sampling frequency Fs of 48 kHz under such condition, the video/audio data transmitting device Tx sets the frequency dividing information N at 6144. Further, when the audio data is outputted with the audio sampling frequency Fs of 96 kHz, the video/audio data transmitting device Tx sets the frequency dividing information N at 12288. The video/audio data receiving device Rx determines the audio sampling frequency Fs based on the frequency dividing information N and the time information CTS transmitted from the video/audio transmitting device Tx. Similarly, it is possible to adjust the audio sampling frequency Fs by changing the frequency dividing information N and the time information CTS in response to the changes in the TMDS clock Ft.

When the audio data is inputted to the video/audio data transmitting device Tx via an SPDIF audio line, the HDMI LSI 15 changes the packet header information part in accordance with the audio data to set the audio sampling frequency Fs. At that time, the HDMI LSI 15 sets the frequency dividing information N and the time information CTS of the audio clock information packet by using the calculating equation (1) described above. The video/audio data receiving device Rx judges the audio sampling frequency Fs based on the received audio data and the audio clock information packet. Japanese Published Patent Document (Japanese Unexamined Patent Publication 2005-65093) depicts detailed contents of judgments on the audio sampling frequency Fs done by the video/audio data receiving device Rx.

When the audio data is inputted to the video/audio data transmitting device Tx via the audio line such as I2S, the HDMI LSI 15 sets the audio sampling frequency Fs by adding a new packet header in accordance with the audio data. At that time, the HDMI LSI 15 sets the frequency dividing information N and the time information CTS of the audio clock information packet by using the calculating equation (1) described above. The video/audio data receiving device Rx judges the audio sampling frequency Fs based on the received audio data and the audio clock information packet.

Now, there is assumed a case where the audio data is outputted with optical signals from the video/audio data transmitting device Tx to the AV AMP 20 that is connected thereto via the optical cable, while only video signals are to be outputted to the video/audio data receiving device Rx (TV set or the like) that is connected via an HDMI cable. In that case, the audio data set by the B/E LSI 11 is outputted to both the AV AMP 20 which is an optical module and the HDMI LSI 15 since there is only a single audio line provided inside the video/audio data transmitting device Tx as a system structure. At that time, the B/E LSI 11 transmits the audio data to both the output targets while having the frequency dividing information N and the time information CTS in a fixed state. Therefore, when outputting the audio data to the AV AMP 20 by setting the audio sampling frequency Fs at 96 kHz, for example, the audio data is outputted also to the video/audio data receiving device Rx with the audio sampling frequency Fs of 96 kHz. However, the video/audio data receiving device Rx (TV set or the like) is not compatible with the audio sampling frequency Fs of 96 kHz or higher, so that the received audio data is ejaculated as a strange sound from a speaker of the video/audio data receiver Rx.

### SUMMARY OF THE INVENTION

The main object of the present invention therefore is to prevent generation of strange noise by keeping audio data outputted from an HDMI LSI at optimal values.

In order to achieve the foregoing object, an audio data transmitting device comprises:

an input device to which audio data is inputted;

an information obtaining device for obtaining information regarding its audio data processing capacity from an audio data receiving device that is a transmission source of the audio data that is inputted to the input device;

an analyzer for analyzing the information obtained by the information obtaining device;

an information adder which generates header information of the audio data suited for the audio data receiving device based on a result of analysis executed by the analyzer, and then adds the header information generated thereby to the audio data that is inputted to the input device;

an information packet generator for generating an audio clock information packet that corresponds to the audio data inputted to the input device; and

an output device for outputting, to the audio data receiving device, superimposed data that is obtained by superimposing the audio clock information packet on the audio data to which the header information is added.

In this structure, the reproduction clock is selected by analyzing the applicable frequency of the audio data receiving device from the information (EDID information) regarding the audio data processing capacity. When the audio data transmitting device and the audio data receiving device are connected, the information (EDID information) regarding the audio data processing capacity of the receiver side can be read out through a DDC line. Therefore, it becomes possible to read out information such as audio sampling frequencies and the number of channels that can be dealt with by the audio data receiving device, and to select a proper audio clock information packet.

There is such a form in the present invention that the audio data transmitting device further comprises a changing device which changes a sampling frequency that is set in the audio data inputted to the input device into a sampling frequency suited for the data receiving device.

Assuming that the audio sampling frequency of the audio data transmitted from the audio data transmitting device cannot be processed at the audio data receiving device, it is possible with this form to set in advance, as the audio sampling frequency set by the audio data transmitting device, one half, one third, one fourth or the like of the original value, or a fixed value of the audio sampling frequency that can be received by any kinds of audio data receiving devices. Then, the audio sampling frequency of the audio data to be transmitted is adjusted to that value, and the audio data having the adjusted audio sampling frequency is transmitted to the audio data receiving device.

There is such a form in the present invention that the output device is capable of limiting a signal level of audio data to be outputted. With this structure, a strange sound that may be generated on the audio data receiving device side can be prevented doubly, by transmitting the audio data after adjusting its audio sampling frequency and then adjusting the signal level of the audio data to be transmitted (for example, adjusting it to “0 level”).

The input device is capable of inputting compressed audio data and uncompressed audio data as the audio data. The compressed data is audio data of IEC50958/61937 standard; and the uncompressed data is audio data that conforms to IEC60958 standard, I2S, a left-justified or right-justified format, and the like.

With the above-described structure capable of inputting the compressed audio data, the audio data can be transmitted by setting the audio sampling frequency of the packet header information to an audio sampling frequency that can be processed by the audio data receiving device. Further, when the audio data receiving device is not capable of dealing with the compressed audio data, it is possible to transmit the audio data by converting it to uncompressed audio data.

With the above-described structure capable of dealing with the uncompressed audio data, it is possible to set the audio sampling frequency to the packet header information, and then to transmit the audio data by adding the packet header information thereto.

The output of the audio clock information packet and the audio data may be stopped simultaneously by setting the audio sampling frequency that can be processed by the audio data receiving device. With that, through setting the audio sampling frequency that can be processed by the audio data receiving device and, further, stopping the output of both the audio clock information packet and the audio data, the information never reaches the audio data receiving device. As a result, generation of strange sounds can be prevented doubly.

It is also possible to stop the output of the audio data by setting the audio sampling frequency that can be processed by the audio data receiving device. By doing so, through setting the audio sampling frequency that can be processed by the audio data receiving device and, further, stopping the output of the audio data only, the information never reaches the audio data receiving device. As a result, generation of strange sounds can be prevented doubly. Further, only the output of the audio data may simply be stopped. With that, through stopping only the output of the audio data, the information never reaches the audio data receiving device. As a result, generation of strange sounds can be prevented.

With the present invention, it is possible to transmit the audio data by setting the audio sampling frequency that is processable for the audio data receiving device based on the information (EDID information) regarding the audio data processing capacity of the audio data receiving device. This makes it possible to prevent generation of strange sounds in the audio data receiving device. Further, through making it possible to limit the signal level of the audio data to be outputted, it becomes possible to increase an effect of preventing the generation of strange sounds.

The present invention can be applied to audio output apparatuses. In particular, the present invention can be applied to AV apparatuses such as DVD players, DVD recorders, and STBs (Set Top Boxes) which have AV output functions.

### BRIEF DESCRIPTION OF THE DRAWINGS

Other objects of the present invention will become clear from the following description of the preferred embodiments and be specified in the appended claims. Those skilled in the art will understand many advantages of the present invention other than described herein by embodying the present invention.

FIG. 1 is an illustration for showing a conventional case;

FIG. 2 is an illustration for showing an embodiment of the present invention;

FIG. 3 is an illustration for showing a conventional case;

FIG. 4 is an illustration for showing an EDID obtaining procedure and a down sampling setting procedure of the present invention;

FIG. 5 is an illustration for showing SPDIF processing of the present invention;

FIG. 6 is an illustration for showing I2S processing of the present invention;

FIG. 7 is an illustration for showing the embodiment on a receiver side;

FIG. 8 is an illustration for showing the embodiment including a sampling controller on the receiver side;

FIG. 9 is an illustration for showing a flowchart of the present invention until obtaining EDID information;

FIG. 10 is an illustration for showing a flowchart of the present invention after obtaining the EDID information;

FIG. 11A is an illustration for showing a flowchart of a conventional case after obtaining EDID information;

FIG. 11B is an illustration for showing a flowchart of a first embodiment according to the present invention after obtaining EDID information;

FIG. 11C is an illustration for showing a flowchart of a second embodiment according to the present invention after obtaining EDID information;

FIG. 12A is an illustration for showing a flowchart of a third embodiment according to the present invention after obtaining EDID information;

FIG. 12B is an illustration for showing a flowchart of a fourth embodiment according to the present invention after obtaining EDID information;

FIG. 12C is an illustration for showing a flowchart of a fifth embodiment according to the present invention after obtaining EDID information;

FIG. 13 is an illustration for showing a processing flow on the receiver side; and

FIG. 14 is an illustration for showing a flowchart of the present invention on the receiver side.

### DETAILED DESCRIPTION OF THE PREFERRED EMBODIMENTS

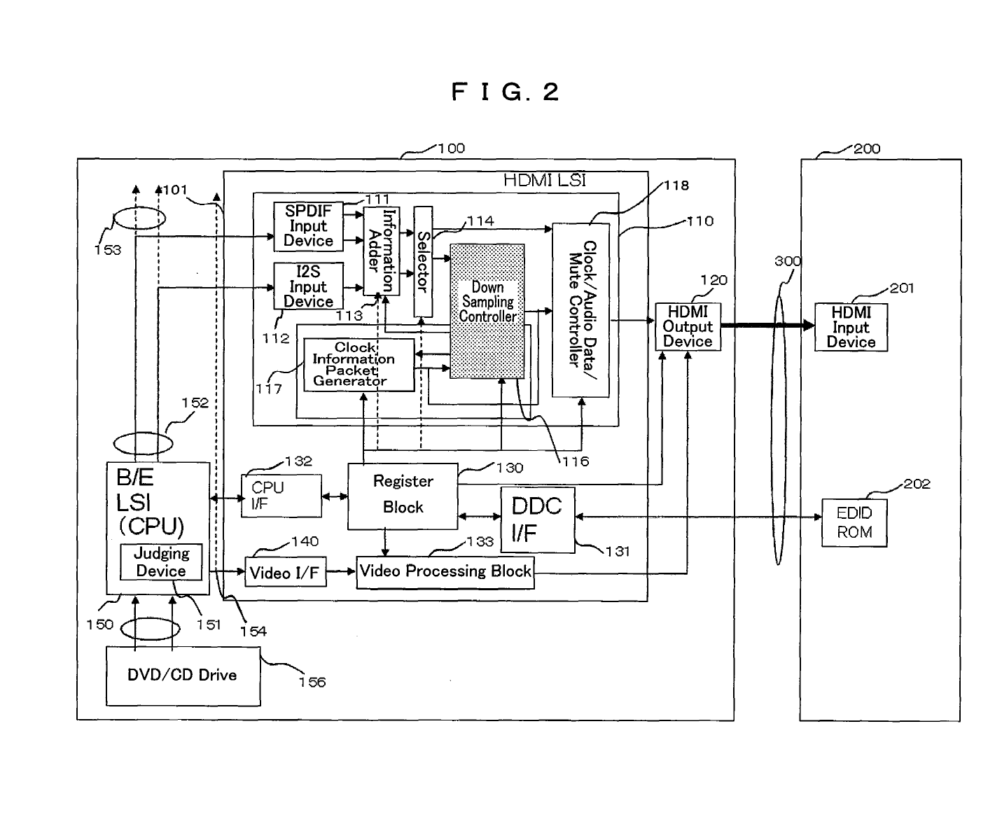

Hereinafter, embodiments of an audio data transmitting device and an audio data receiving device according to the present invention will be described in detail by referring to the accompanying drawings. FIG. 2 is a block diagram for showing structures on a transmitter side (audio data transmitting device) in an HDMI communication system which includes a digital transmission system and a clock generating device according to the embodiment.

The HDMI communication system shown in FIG. 2 comprises a video/audio data transmitting device 100 (a DVD player or the like) as an example of an audio data transmitting device and a video/audio data receiving device 200 (a TV receiver set or the like) as an example of an audio data receiving device. The video/audio data transmitting device 100 and the video/audio data receiving device 200 are connected via an HDMI cable 300.

The video/audio data transmitting device 100 transmits video data and audio data to the video/audio data receiving device 200 via the HDMI cable 300. The video/audio data transmitting device 100 performs DDC communication with the video/audio data receiving device 100 via the HDMI cable 300. The video/audio data transmitting device 100 uses the DDC communication to perform apparatus authentication on the video/audio data receiving device 200 based on the HDCP standard. The video/audio data transmitting device 100 comprises an HDMI LSI 101 and a B/E LSI 150.

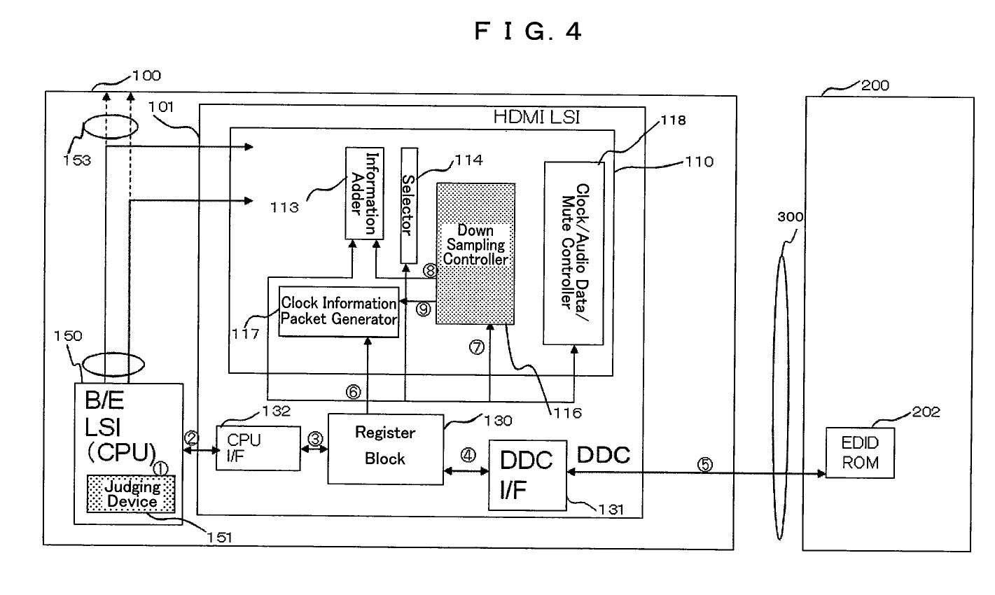

The B/E LSI 150 comprises a judging device 151 for performing control of the entire video/audio data transmitting device. The video/audio data transmitting device 100 reads out EDID information from the video/audio data receiving device 200 through the DDC communication after confirming a connection between the video/audio data receiving device 200 and itself. The EDID information is read out by the CPU I/F 132, a register block 130, a DDC I/F 131, and an EDID ROM 202 which work together. FIG. 4 shows the details of EDID information readout processing.

FIG. 4 shows flows of the processing for reading out the EDID information and controlling audio sampling frequency Fs executed by the audio data transmitting device and the audio data receiving device according to the embodiment. Selectively illustrated therein are the B/E LSI 150, the judging device 151, the CPU I/F 132, the register block 130, the DDC I/F 131, the HDMI cable 300, the EDID ROM 202, a clock information packet generator 117, a selector 114, a down sampling controller 116, and a clock/audio data/mute controller 118, which play important roles for the EDID information readout processing and the Fs control processing.

When the video/audio data transmitting device 100 confirms the connection with the video/audio data receiving device 200, the judging device 151 executes readout processing of the EDID information. The EDID information is read out through the processing of (1)→(2)→(3)→(4)→(5)→(4)→(3)→(2)→(1) shown in FIG. 4. This processing will be described in the following.

First, the judging device 151 transmits a readout instruction of the EDID information to the register block 130 via the CPU I/F 132. The readout instruction is executed through a flow of (1)→(2)→(3) shown in FIG. 4. Upon receiving the EDID information readout instruction, the register block 130 obtains the EDID information from the EDID ROM 202 of the video/audio data receiving device 200 by the DDC communication via the DDC I/F 131 through the HDMI cable 300. The EDID information is obtained through a flow of (4)→(5)→(4) shown in FIG. 4. The judging device 151 within the B/E LSI 150 fetches and retains the obtained EDID information via the CPU I/F 132. The EDID information is retained through a flow of (3)→(2)→(1) shown in FIG. 4.

The EDID information contains the apparatus information regarding the type of signals that can be processed with HDMI, panel resolution information, pixel clock information, horizontal effective period information, vertical effective period information, information of the maximum audio sampling frequency Fs, and the like, and it is the information required for controlling the HDMI LSI 101. The judging device 151 controls each of the blocks such as the clock information packet generator 117, an information adder 113, the selector 114, the down sampling controller 116, and the clock/audio data/mute controller 118 of the HDMI LSI 101, based on the retained EDID information. The control of each block are executed through a flow of (1)→(2)→(3)→(6) shown in FIG. 4.

The judging device 151 also performs control of the entire video/audio data transmitting device 100 in addition to the control for obtaining the EDID information. When a recording medium such as a CD or a DVD is loaded to the video/audio data transmitting device 100 so that the data can be read, the B/E LSI 150 obtains the video data and the audio data reproduced by a DVD/CD drive 156. The B/E LSI 150 of the video/audio data transmitting device 100 sets resolution information, color information, audio sampling frequency Fs information, channel information, and the like for the obtained data. Those pieces of information are set based on the EDID information and the like retained in the judging device 151. The video data to which the various kinds of information are set is transmitted from a video data transmission line 154 to the HDMI LSI 101, and the audio data is transmitted from an audio data transmission line 152 to the apparatus to which the audio data transmission line 152 is connected. The audio data transmission line 152 includes an I2C line and an SPDIF line. The I2C line employs a left-justified data format or a right-justified data format with which the data is outputted by synchronizing with the I2S or L-R clock output. The B/E LSI 150 transmits the audio data to an I2S input 112 of the HDM1 LSI and an SPDIF input 111, respectively, via the line 152 (including the I2S line and the SPDIF line).

The HDMI LSI 101 comprises an audio control block 110, a video processing block 133, and the register block 130 for controlling a register. Video data is transmitted to the video processing block 133 from the B/E LSI 150. Video data is transmitted to the video processing block 133 from the video data transmission line 154 via a video I/F 140. The video processing block 133 applies various kinds of signal processing on the transmitted video data, and transmits the processed video data to the video/audio data receiving device 200 from an HDMI output device 120.

The register block 130 controls the actions for obtaining the EDID information using IIC communication and DDC communication. Further, the register block 130 controls actions of the clock information packet generator 117, the selector 114, the down sampling controller 116, the clock/audio data/mute controller 118, and the video processing block 133. These actions are controlled based on instructions from the judging device 151.

The audio control block 110 comprises: the SPDIF input device 111; the I2S input device 112; the down sampling controller 116 that performs down sampling processing; the clock information packet generator 117 that generates the audio clock information packet; and the clock/audio data/mute controller 118 that performs controls of the audio data and the audio clock information packet as well as mute control. The SPDIF input device 111 and the I2S input device 112 receive the audio data from the B/E LSI 150.

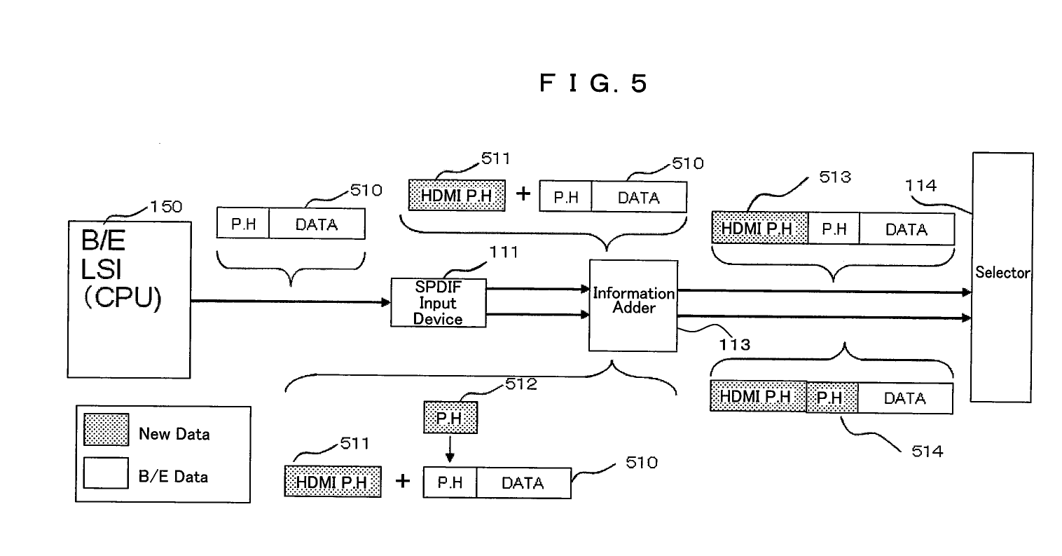

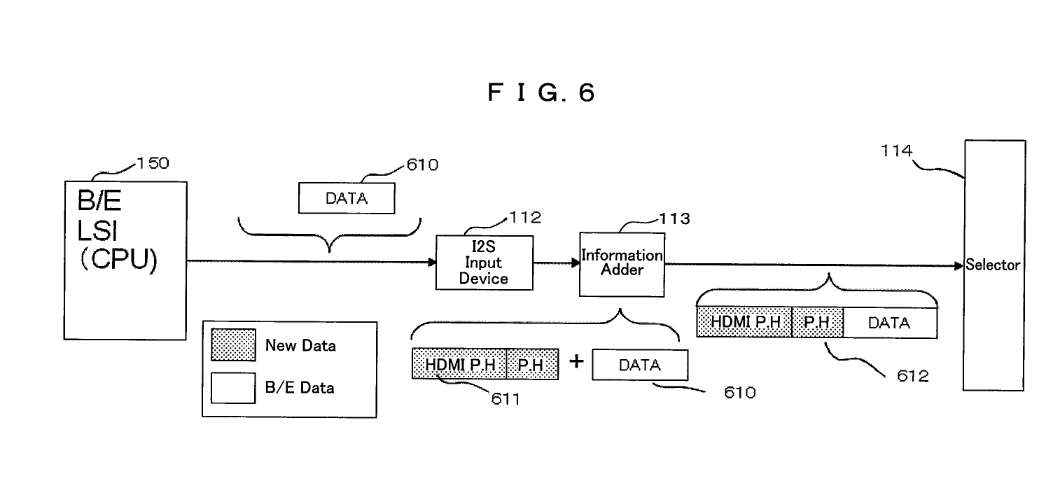

The audio data transmitted from the B/E LSI 150 to the SPDIF input device 111 and the I2S input device 112 is controlled by the information adder 113 and the selector 114. FIG. 5 shows the details of the SPDIF from the B/E LSI 150 to the selector 114, and FIG. 6 shows the details of the I2S from the B/E LSI 150 to the selector 114.

In the case of the SPDIF shown in FIG. 5, audio data 510 is transmitted from the B/E LSI 150 to the SPDIF input device 111. In FIG. 5, “P.H” indicates packet header information, and “DATA” indicates audio DATA information. When judging that the transmitted audio data 510 needs to change the audio sampling frequency Fs, and channel number information, and the like, the information adder 113 writes “P.H 512” which serves as header information of the number of channels and a new audio sampling frequency Fs over the audio data 510. Further, the information adder 113 adds “HDMI.P.H 511” which serves as the packet header information inside the HDML LSI 101 to the audio data 510. Then, the information adder 113 transmits, to the selector 114, the audio data 510 (which has been overwritten) to which “HDMI.H.P 511” is added, as audio data 514. When it is unnecessary to change P.H, the information adder 113 transmits, as audio data 513, the audio data 510 (which has not been overwritten) to which “HDMI.H.P 511” is added to the selector 114.

In the case of the I2S processing shown in FIG. 6, audio data 610 is outputted from the B/E LSI 150 to the I2S input device 112. In the I2S processing, normally, only the audio data to which the packet information is not added is transmitted, unlike the case of the SPDIF. Thus, in the I2S processing, the I2S input device is to receive the audio data 610 having no packet header information. In this embodiment, the audio data 610 received at the I2S input device 112 is inputted to the information adder 113, where the audio sampling frequency required in the I2S processing and “HDMI. P. H 611” which serves as the channel header information are added to the audio data 610. The audio data 610 to which the header information is added in this manner is referred to as audio data 612 hereinafter. The audio data 612 is transmitted to the selector 114. The I2S processing is note limited to the normal I2S processing, but the I2S processing executed herein may be the processing having a left-justified format or a right-justified format with which the data is outputted in sync with the L-R clock output.

Described above are the details of the SPDIF and I2S processing regarding FIG. 5 and FIG. 6. The information adder 113 adjusts the value of the audio sampling frequency Fs in the packet header information in the manner described above based on the EDID information retained in the judging device 151. The flow of (1)→(2)→(3)→(6) in FIG. 4 can be referred to for this processing. There may also be a case where the information regarding the audio sampling frequency Fs is transmitted from the down sampling controller 116 to the information adder 113. The flow of (1)→(2)→(3)→(6)→(7)→(8 or 9) in FIG. 4 can be referred to for this state. Even in this case, the clock information packet generator 117 also generates the audio clock information packet including the frequency dividing information N and the time information CTS based on the information of the audio sampling frequency Fs.

After the above-described processing is completed, the selector 114 receives the audio data. The selector 114 can switch between the I2S audio data of the I2S and the SPDIF audio data and output either of them based on an instruction of the judging device 151 (see the flow of (1)→(2)→(3)→(6) in FIG. 4).

When the judging device 151 judges that it is necessary to change the setting of the audio sampling frequency Fs based on an analysis of the EDID information, the audio data received at the selector 114 is transmitted to the down sampling controller 116. Inversely, when the judging device 151 judges that it is unnecessary to change the setting of the audio sampling frequency Fs, the audio data received at the selector 114 is transmitted to the clock/audio data/mute controller 118.

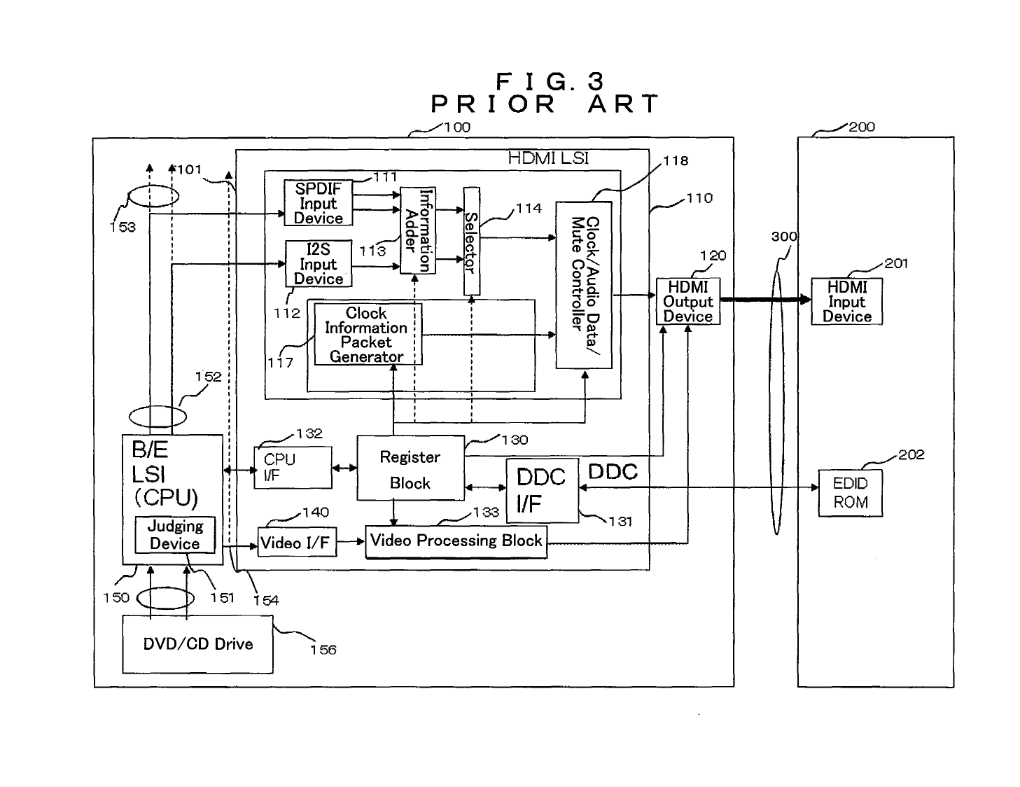

In order to explain the point that is different from a conventional technique, a conventional case is illustrated in FIG. 3. In a structure of the conventional case, the down sampling controller 116 shown in FIG. 2 is not provided. The selector 114 transmits the whole audio data to the clock/audio data/mute controller 118.

The clock information packet generator 117 shown in FIG. 2 generates the audio clock information packet that contains the frequency dividing information N and the time information CTS. The frequency dividing information N and the time information CTS are calculated by the calculating equation (1) based on the information (generated through the flow of (1)→(2)→(3)→(6) in FIG. 4) from the judging device 151, or the information (generated through the flow of (1)→(2)→(3)→(6)→(7)→(8 or 9) in FIG. 4) of the audio sampling frequency Fs that is set by the down sampling controller 116. The clock information packet generator 117 generates the audio clock information packet based on the calculated frequency dividing information N and time information CTS.

When judging that it is necessary to change the setting of the audio sampling frequency Fs in the audio clock information packet based on the analysis of the EDID information, the selector 114 transmits the audio data to which the audio clock information packet is added, to the down sampling controller 16. Inversely, when judging that it is unnecessary to change the setting of the audio sampling frequency Fs, the selector 114 transmits the audio data to the clock/audio data/mute controller 118.

The down sampling controller 116 transmits the audio data (which needs to change the value of the audio sampling frequency Fs), which is transmitted via the selector 114, to the information adder 113 and the clock information packet generator 117 to cause those processors 113 and 117 to reset the audio sampling frequency Fs of the audio data. FIG. 4 shows the flow of control on resetting the audio sampling frequency Fs executed by the down sampling controller 116. Resetting of the audio sampling frequency Fs is executed through the flow of (1)→(2)→(3)→(6)→(7)→(8 or 9) in FIG. 4. The resetting of the audio sampling frequency Fs will be described in detail hereinafter.

First, the judging device 151 generates the information indicating whether or not to reset (down sampling) the audio sampling frequency Fs and the setting information of the audio sampling frequency Fs used when it is reset, based on the EDID information. The judging device 151 transmits the generated information to the down sampling controller 116 via the register block 130. The information is transmitted through a flow of (1)→(2)→(3)→(6)→(7) in FIG. 4. The down sampling controller 116 transmits the information transmitted from the judging device 151 to the information adder 113 ((8) in FIG. 4) and to the clock information packet generator 117 ((9) in FIG. 4). With reference to the case when resetting audio sampling frequency Fs in the already-generated audio data and in the audio clock information packet, the processing thereof is executed through a flow of (8) and (9) in FIG. 4 as well.

Regarding the resetting of the audio sampling frequency, it is also possible to fix the value of the audio sampling frequency Fs or to set the value by changing it to one half or one fourth of the original value. When setting it at a fixed value, it is possible to:
fix the value to the minimum audio sampling frequency Fs obtained from the EDID information; or
fix the value to the audio sampling frequency Fs that can be received by all the apparatuses.

### When setting the audio sampling frequency Fs by changing it to one half or one fourth of the original value, the judging device 151 changes the original value to one half or one fourth based on the EDID information.

Details of the control on setting the audio sampling frequency Fs to an arbitrary fixed value or a fixed value obtained by changing to one half or one fourth of the original value will be described by referring to FIG. 4. In the explanation in the following will be provided on assumption that:
192 kHz is set as the audio sampling frequency; and
the video/audio data receiving device 200 retains the EDID information within the EDID ROM 202, of which the maximum Fs output is 96 kHz.

When the video/audio data transmitting device 100 and the AV AMP (the connection-target apparatus of the audio line 153) are connected through an optical cable via the audio line 153, the information regarding the audio sampling frequency Fs is transmitted to the HDMI LSI 101 and the AV AMP via the audio data transmission line 152.

With this:
the video/audio data transmitting device 100 changes to a mode (mode for giving no priority to the HDMI audio output) for giving priority to outputting the audio output to the AV AMP, since the B/E LSI 150 is already connected to the AV AMP (the connection-target apparatus of the audio line 153); and
when the HDMI (the video/audio data transmitting device 200) is connected, the audio sampling frequency Fs (192 kHz) that conforms to the output to the AV AMP is transmitted to the HDMI LSI 101.

On the other hand, when the AV AMP (the connection-target apparatus of the audio line 153) is disconnected from the audio line 153:
the video/audio data transmitting device 100 changes to a mode for giving priority to outputting the audio to the HDMI (video/audio data receiving device 200); and
it becomes possible to change the audio sampling frequency Fs by the B/E LSI 150.

Further, in the case of setting the down sampling with the fixed value 48 kHz of the audio sampling frequency Fs under the above-described condition, when the video/audio data receiving device 200 is connected to the video/audio data transmitting device 100 via the HDMI, the judging device 151 obtains the EDID information retained in the EDID ROM 202 through the above-described EDID information obtaining processing (the flow of (1)→(2)→(3)→(4)→(5)→(4)→(3)→(2)→(1) in FIG. 4). The judging device 151 judges, based on the obtained EDID information, whether or not the audio sampling frequency Fs (192 kHz) that is set when the audio data is outputted to the HDMI LSI 101 is effective for the video/audio data receiving device 200 that is the HDMI connection target. In this case, it is judged that the audio sampling frequency Fs needs to be down sampled to the fixed value 48 kHz, by comparing the maximum Fs output (96 kHz) of the video/audio data receiving device 200 based on EDID information with the set audio sampling frequency Fs (192 kHz). Upon making such judgment, the judging device 151 transmits down sampling instruction information and Fs setting information 48 kHz to the down sampling controller 116 via the register block 130. This transmission of the information is executed through the flow of (1)→(2)→(3)→(6)→(7) shown in FIG. 4.

Upon receiving the information that the down sampling is to be performed, the down sampling controller 116 transmits the transmitted Fs setting information (48 kHz) to the information adder ((8) in FIG. 4) and, further, transmits the Fs setting information (48 kHz) to the clock information packet generator 117 ((9) in FIG. 4). The information adder 113 generates audio data by setting the received Fs setting information (48 kHz) to the packet information header (512 of FIG. 5 or 611 of FIG. 6). The clock information packet generator 117 generates audio clock information packet from the frequency dividing information N and the time information CTS in the received Fs setting information (48 kHz) by applying the above-described calculating equation (1).

When setting the down sampling by changing the audio sampling frequency Fs to one half or one fourth of the original value under the same condition, the judging device 151 obtains the EDID information retained in the EFID ROM 202 through the above-described EDID information obtaining processing (the flow of (1)→(2)→(3)→(4)→(5)→(4)→(3)→(2)→(1) shown in FIG. 4) after the video/audio data receiving device 200 is connected to the video/audio data transmitting device 100 via the HDMI. The judging device 151 judges, based on the obtained EDID information, whether or not the audio sampling frequency value (192 kHz) at the time of outputting the audio to the HDMI LSI 101 is effective for the video/audio data receiving device 200 that is the HDMI connection target. The judging device 151 in this embodiment compares the maximum Fs output (96 kHz) of the video/audio data receiving device 200 set in the EDID information with the audio sampling frequency Fs (192 kHz) under an output state. As a result, the judging device 151 judges that it is necessary to down sample the audio sampling frequency Fs to half the value, that is, 96 kHz. Upon making such judgment, the judging device 151 transmits the down sampling instruction information and the Fs setting information (96 kHz) to the down sampling controller 116 via the register block 130 through the flow of (1)→(2)→(3)→(6)→(7) shown in FIG. 4. Upon receiving the down sampling instruction information and the Fs setting information (96 kHz), the down sampling controller 116 transmits the received Fs setting information (96 kHz) to the information adder 113 ((8) in FIG. 4) and, further, transmits it to the clock information packet generator 117 ((9) in FIG. 4). The information adder 113 generates audio data through applying the processing, which is described above by referring to FIG. 5 and FIG. 6, to the received Fs setting information (96 kHz), based on the setting Of the packet information header (512 of FIG. 5 or 611 of FIG. 6). The clock information packet generator 117 substitutes the audio frequency dividing information N and the time information CTS as the contents of the Fs setting information (96 kHz) into the calculating equation (1), so as to generate the audio clock information packet based on the obtained value. Described above is the embodiment for setting the audio sampling frequency Fs to a prescribed fixed value, or a fixed value obtained by changing to one half or one fourth of the original value.

The clock/audio data/mute controller 118 can perform control for stopping or muting the audio data and the audio clock information packet. When stopping the audio data only, the clock/audio data/mute controller 118 stops only the audio data, and performs normal processing of the clock information packet. When stopping both the audio clock information packet and the audio data, the clock/audio data mute controller 118 stops both the audio clock information packet and the audio data. Further, when performing the mute processing, the clock/audio data/mute controller 118 outputs the audio data that is converted to “0 data” as the mute information.

The audio block 110 transmits the audio data to the video/audio data receiving device 200 from the HDMI output 120 via the HDMI cable 300. The audio data is handled in the audio data block 110 in the same way as the video data is handled in the video processing block 133.

As described above, in the digital transmission system and the clock generating device according to the embodiment, the video data transmitted from the B/E LSI 150 is processed in the video processing block 133, and the audio data is processed in the audio block 110 based on the EDID information obtained from the register block 130. Then, the video data and the audio data are transmitted to the video/audio data receiving device 200 through the HDMI output device 120.

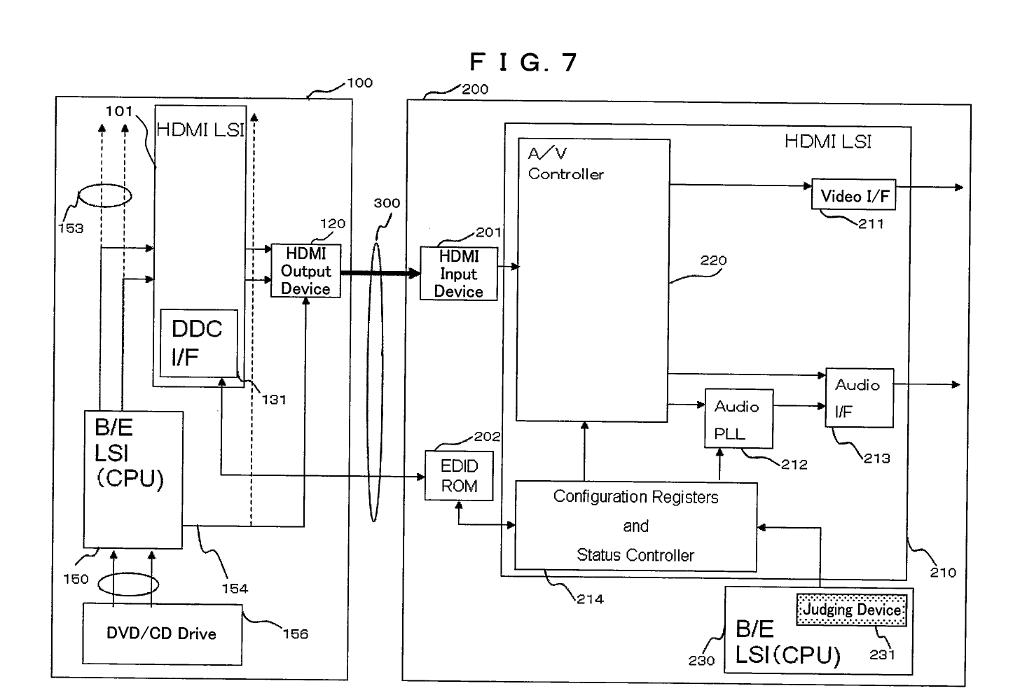

FIG. 7 is a block diagram showing the receiver-side structure of an HDMI communication system that comprises the digital transmission system and the clock generating device according to the embodiment. The HDMI information received at an HDMI input device 201 is transmitted to an A/V controller 220. The A/V controller 220 is provided at an HDMI LSI 210 so as to perform control of video data and audio data. The A/V controller 220 transmits video data of the received HDMI information to a video I/F 211, transmits audio data to an audio I/F 213, and transmits a clock to an audio PLL 212.

The B/E LSI 230 comprises a judging device 231 for performing control of the entire video/audio data receiving device. The judging device 231 performs control of each block based on received HDMI information and the like. The B/E LSI 230 performs the control in cooperation with a configuration registers and status controller 214. Based on the control contents transmitted from the B/E LSI 230, the configuration registers and status controller 214 performs control of the A/V controller 220, the audio PLL 212, and the EDID ROM 202. Control herein means the control of each processing block such as mute processing and EDID reading. The audio PLL 212 generates a clock used in the video/audio data receiving device 200 based on the clock of the video/audio data transmitting device side.

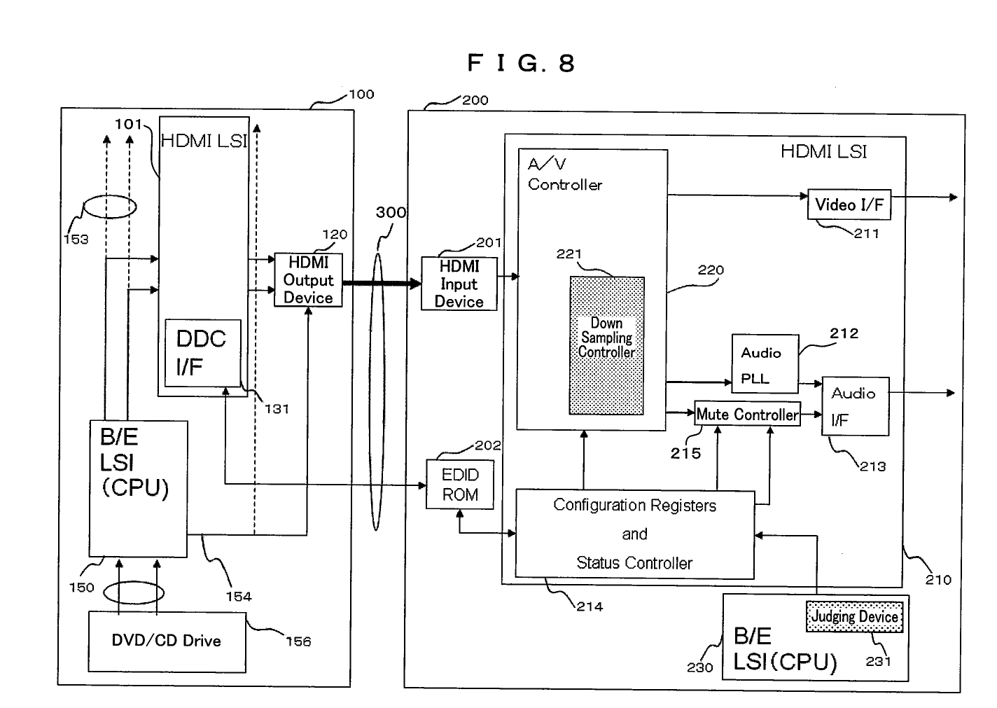

FIG. 8 shows the structure where the down sampling controller 221 is provided on the receiver side. When the A/V controller 220 receives the audio data, the down sampling controller 221 (provided in the A/V controller 220) compares the audio sampling frequency Fs of the audio data with receiver-side maximum output Fs information that is stored in the EDID ROM 202. When the received audio sampling frequency Fs exceeds the maximum output Fs, the down sampling controller 221 judges that it is possible to reset frequency dividing information N and time information CTS and make them suited for the receiver side. The mute controller 215 performs mute control based on the control contents transmitted from the configuration registers and status controller 214. In this case, audio data that is down sampled in accordance with the frequency dividing information N and the time information CTS is transmitted from the A/V controller 220. However, the mute controller 215 can mute the audio data by making it “0 data”.

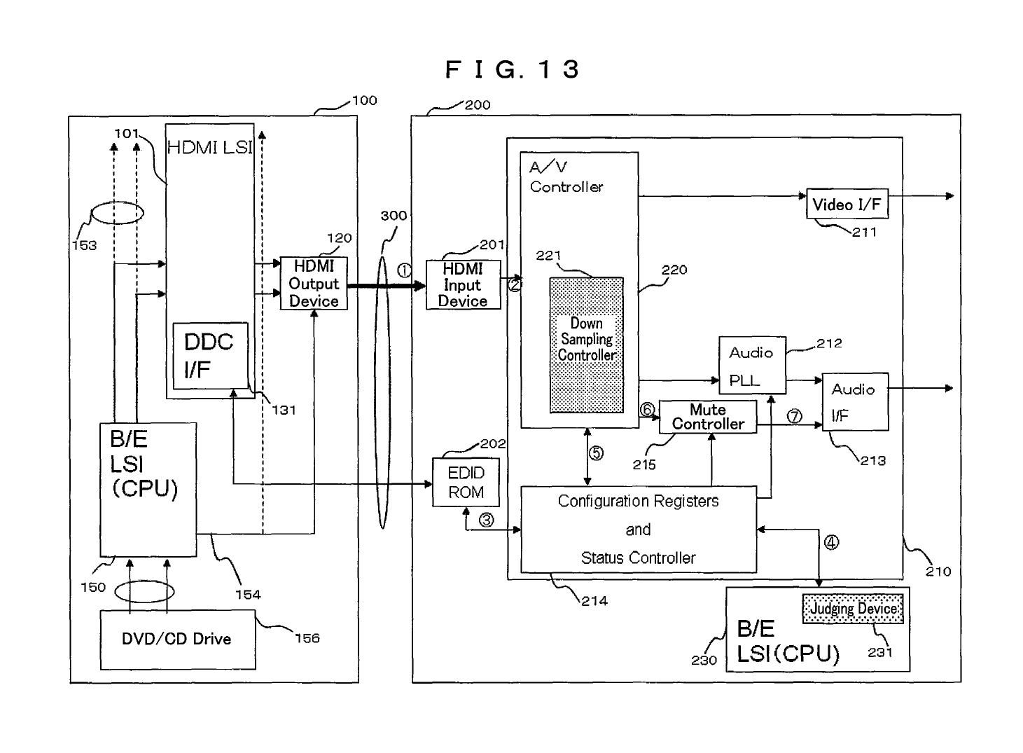

Now, by referring to FIG. 13, there will be described the processing for a case where the video/audio data transmitting device 100 transmits the frequency dividing information N and the time information CTS which correspond to the audio sampling frequency Fs (96 kHz) to the video/audio data receiving device 200 (applicable audio sampling frequency Fs is 48 kHz). When the frequency dividing information N and the time information CTS of the audio sampling frequency Fs (96 kHz) is mistakenly transmitted from the HDMI output device 120 to the HDMI input device 201 via the HDMI cable 300, the HDMI input device 201 transmits the received frequency dividing information N and time information CTS to the A/V controller 220 (the flow of (1)→(2) shown in FIG. 13).

The B/E LSI (CPU) 230 obtains the receivable maximum Fs information (indicating that the audio sampling frequency Fs of up to 48 kHz can be received) which is stored in the EDID ROM 202 (the flow of (3)→(4) in FIG. 13). Further, the judging device 231 fetches the frequency dividing information N (96 kHz: corresponds to the audio sampling frequency Fs of 96 kHz) and the time information CTS (96 kHz: corresponds to the audio sampling frequency Fs of 96 kHz) from the A/V controller 220, and compares those sets of information with the receivable maximum Fs information (48 kHz) obtained from the EDID ROM 220 (the flow of (5)→(4) in FIG. 13).

In this case, the judging device 231 judges that the audio sampling frequency Fs (96 kHz) indicated by the frequency dividing information N (96 kHz) and the time information CTS (96 kHz) which are fetched from the A/V controller 220 is larger than the audio sampling frequency Fs (48 kHz) of the receivable maximum Fs information (48 kHz). Upon making such judgment, the judging device 231 transmits the control information for performing down sampling to the A/V controller 220 (the flow of (4)→(5) in FIG. 13).

When the A/V controller 220 receives the down sampling control information, the down sampling controller 221 provided in the A/V controller 220 performs the following control ((6) in FIG. 13). That is, the control of:
resetting the Fs value in the frequency dividing information N and the time information CTS so as to make an Fs value processable, and then transmitting the clock to the audio PLL 212 and the audio data to the mute controller 215; or
performing the processing to stop the clock and the audio data so that there is no strange sound generated at the time of output.

When judging that the frequency dividing information N and the time information CTS cannot be processed by this audio data receiving device, the judging device 231 can also transmit the mute control information to the mute controller 215 to cause the mute controller 215 to execute the mute processing of the audio data, and then transmit the mute-processed audio data to the audio I/F 213 (the flow of (4)→(7) in FIG. 13). Through executing the processing by following the flow of (1)-(7) shown in FIG. 13 in the manner as described above, it becomes possible for the receiving device 200 to deal with the audio data that carries the frequency dividing information N and the time information CTS which are not applicable to the receiving device 200.

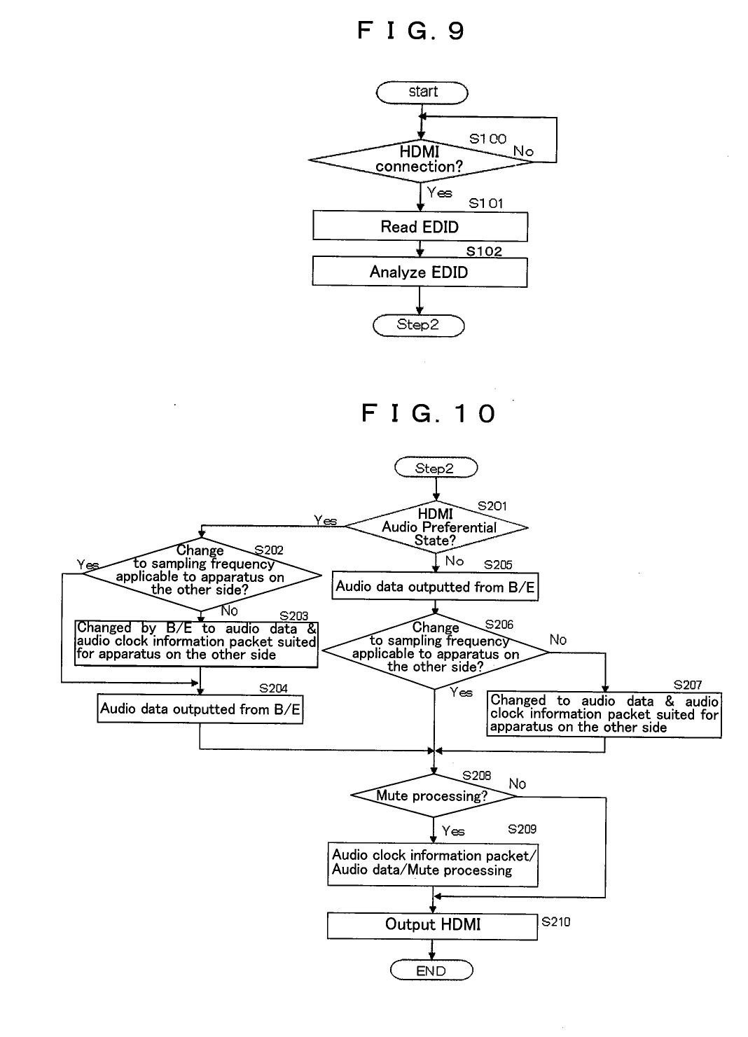

FIG. 9 and FIG. 10 illustrate flowcharts for showing overall flow of the video/audio data transmitting device 100. As shown in FIG. 9, the video/audio data transmitting device 100 checks the HDMI connection until it confirms that it is connected with the video/audio data receiving device 200 (S100). When the HDMI connection is confirmed, the video/audio data transmitting device 100 judges that the video/audio data receiving device 200 has been recognized. Upon this, the video/audio data transmitting device 100 starts the following connection processing. That is, reading of the EDID information is started via the register block 130 (S101). When the reading of the EDID information is completed, the EDID information is analyzed (S102). Through the analysis of the EDID information, information of Fs that is applicable to the video/audio data receiving device, the number of channels, compatibility with the SPD IF and I2S, and the like are read out. The read out information is used when the B/E LSI 150 makes judgments. After completing the analysis of the EDID information, the procedure is shifted to STEP 2 (see FIG. 10).

In STEP 2, first, it is judged whether or not the video/audio data transmitting device 100 is under an HDMI audio preferential state (S201). When confirmed by the judgment of S201 that the video/audio data transmitting device 100 and the video/audio data receiving device 200 are connected via the HDMI but no audio apparatus other than the HDMI is connected to the video/audio data transmitting device 100, it is judged that the sate is under an HDMI audio output preferential mode. With such judgment, it is considered necessary to adjust the audio sampling frequency Fs by the B/E LSI 150, and the procedure is shifted to S202.

In the meantime, when confirmed by the judgment of S201 that the video/audio data transmitting device 100 and the video/audio data receiving device 200 are connected via the HDMI and other audio apparatus than the HDMI is also connected to the video/audio data transmitting device 100, it is judged that the state is under an HDMI audio output non-preferential mode. With such judgment, it is considered necessary to adjust the audio sampling frequency Fs by the HDMI LSI 214, and the procedure is shifted to S205.

In the processing of S202 that is performed when S201 judges that the video/audio transmitting device 100 is under the HDMI audio output preferential mode, it is judged whether or not it is necessary to perform the processing of the audio sampling frequency Fs by the B/E LSI 150 first (S202). When judged in S202 that it is necessary to change the audio sampling frequency Fs, the audio sampling frequency Fs of the B/E LSI 150 is calculated. Then, the calculated audio sampling frequency Fs is set to the audio data and the audio clock information packet which are applicable to the audio data receiving device 200 (S203). This setting processing is performed based on the EDID information analyzed in S102. Thereafter, the audio data is outputted from the B/E LSI 150 (S204).

In the meantime, when judged in S202 that the changing processing of the audio sampling frequency Fs is unnecessary, the audio data is outputted without performing any processing (s204). Then, the procedure is shifted to judgment of mute setting processing (S208).

In the processing of S205 that is performed when S201 judges that the video/audio transmitting device 100 is under the HDMI audio output non-preferential mode, the B/E LSI 150 outputs the audio data without performing any processing (S205) because the audio sampling frequency is adjusted by the HDMI LSI 101. In this case, the B/E LSI 150 outputs the preferential audio data. After the B/E LSI 150 outputs the audio data, the audio sampling frequency Fs of the audio data transmitted from the B/E LSI 150 is calculated. Then, the calculated audio data audio sampling frequency Fs is compared with the EDID information that is analyzed in S102 to judge whether or not it is necessary to change the audio sampling frequency Fs (S206).

When judged in S206 that the change of the audio sampling frequency Fs is unnecessary, the procedure is shifted to judgment of the mute setting processing (S208) without performing any special processing. On the other hand, when judged that the change of the audio sampling frequency Fs is necessary, the audio data and the audio clock information packet are changed to the audio data and the audio clock information packet suited for the video/audio data receiving device 200 based on the changed audio sampling frequency Fs (S207). Specifically, the clock information packet setting device 117 adjusts the frequency dividing information N and the time information CTS so that the information adder 113 can set the audio sampling frequency Fs to a fixed value, one half or one fourth of the initial value based on the judgment result of the judging device 151 that the change of the audio sampling frequency Fs is necessary. When the adjustments of the frequency dividing information N and the time information CTS are completed, the procedure is shifted to judgment of mute setting processing (S208).

When judged in S208 that mute setting is unnecessary, the procedure is shifted to S210 to transmit the HDMI output without performing any processing. On the other hand, when judged necessary, the procedure is shifted to S209 where any of following processing is selectively executed:
processing for stopping output of the audio data only;
processing for stopping output of both the audio clock information packet and the audio data; or
processing for outputting “0 data” as the audio data.

By variously changing the audio clock information packet, the audio data, and the mute setting, the processing to be executed in S209 is selected from among the above-described processing. The audio clock information packet and the audio data set by the above-described sequential control are outputted from the HDMI output device 120 to the video/audio data receiving device 200 (S210).

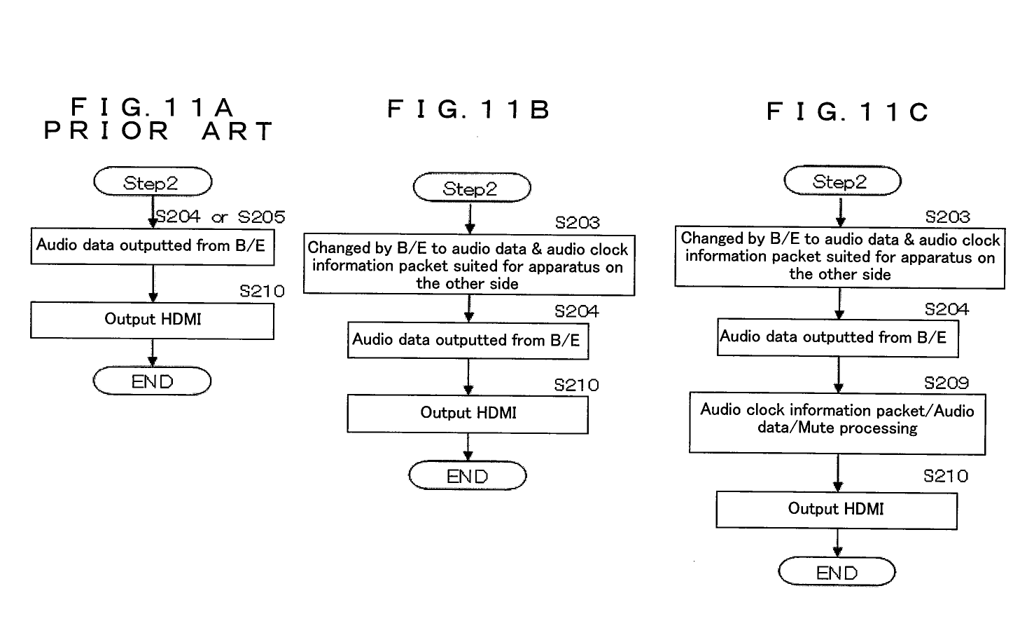

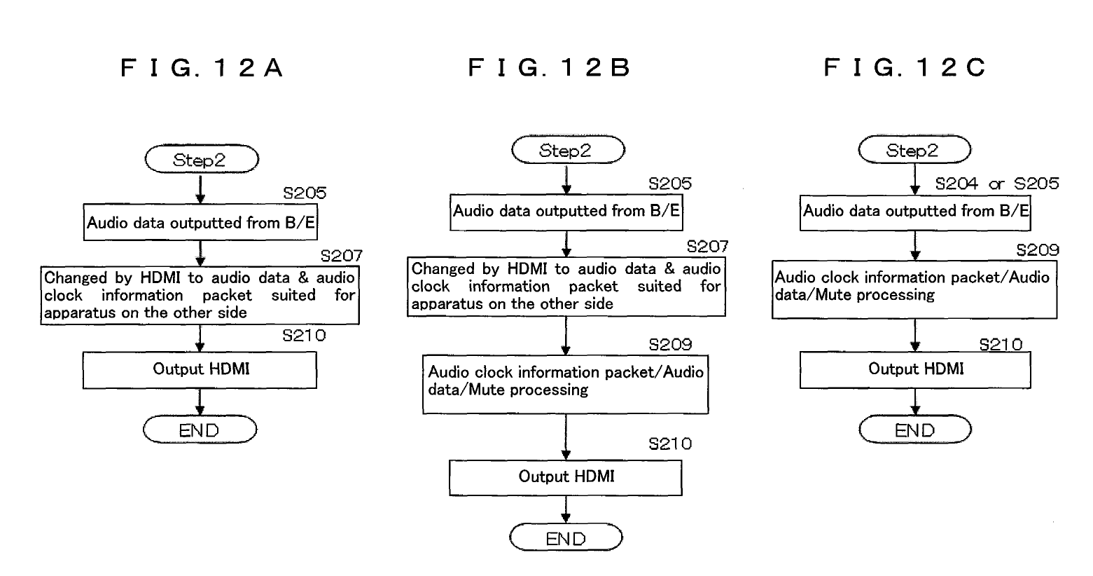

FIG. 11B-FIG. 11C and FIG. 12A-FIG. 12C are illustrations of the embodiments according to the present invention. FIG. 11A shows a conventional method where the B/E LSI 150 outputs the audio data (S204 or S205) without performing the adjusting processing of the audio sampling frequency Fs (S203) and the mute processing (S208). This is the method adopted conventionally.

In a first embodiment shown in FIG. 11B, the adjusting processing of the audio sampling frequency Fs is performed by the B/E LSI 150 (S203), and then the audio data is outputted from the B/E LSI 150 (S204).

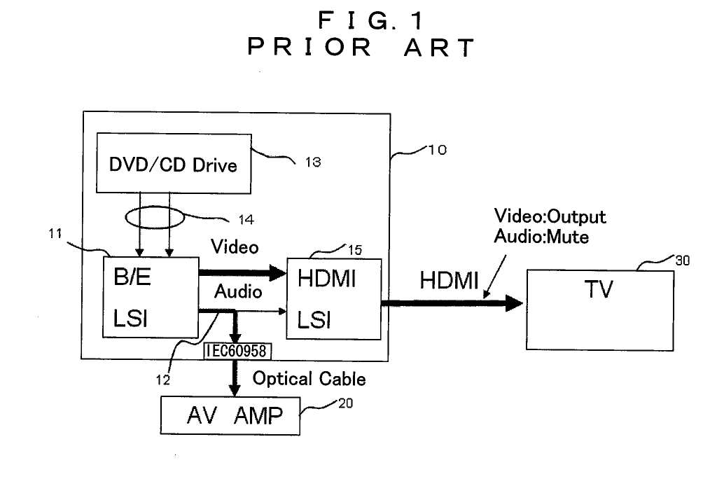

In a second embodiment shown in FIG. 1C, the adjusting processing of the audio sampling frequency Fs is performed by the B/E LSI 150 (S203), and then the audio data is outputted from the B/E LSI 150 (S204). Further, the audio clock information packet/audio data/mute is set (S209).

In a third embodiment shown in FIG. 12A, the audio data is outputted from the B/E LSI 150 (S205). Then, the adjusting processing of the audio sampling frequency Fs is performed by the HDMI LSI 101 (S207).

In a fourth embodiment shown in FIG. 12B, the audio data is outputted from the B/E LSI 150 (S205), and the adjusting processing of the audio sampling frequency Fs is performed by the HDMI LSI 101 (S207). Further, the audio clock information packet/audio data/mute is set (S209).

In a fifth embodiment shown in FIG. 12C, the audio data is outputted from the B/E LSI 150 (S204 or S205), and the audio clock information packet/audio data/mute is set (S209). The fifth embodiment is the processing that requires no down sampling control of the HDMI LSI 101, and it is possible to switch between the processing for stopping the audio data only and the processing for stopping both the audio clock information packet and the audio data by the audio clock information packet/audio data/mute setting processing (S209).

When the processing of the audio sampling frequency Fs is executed in S207 as in the case of the fourth embodiment and the fifth embodiment, it is better to execute the audio clock information packet/audio data/mute processing (S209).

The fifth embodiment is the best among the first to fifth embodiments. The reasons for this will be described in the following. In the fifth embodiment, the frequency Fs suited for the apparatus on the other side (the video/audio data receiving device 200) is set by the HDMI LSI 101 as the audio sampling frequency Fs of the audio clock information packet and the audio data (S207). Then, the processing for rewriting “0 data” into the audio data is performed as the mute processing (S209). This method is the best for the video/audio data transmitting device 100 side. The reason that the mute processing for changing the audio data to “0 data” is the best is as follows.

As described above, there are three types of the mute processing. The three types are:
processing for stopping output of the audio data only;
processing for stopping output of both the audios clock information packet and the audio data; and
processing for outputting “0 data” as the audio data.

There is a possibility that the audio clock information packet and the audio data may disturb the display state of the video/audio data receiving device 200. However, there is no such influence imposed upon the video/audio data receiving device 200 in the processing where the “0 data” is outputted as the audio data. Therefore, the processing of outputting the “0 data” as the audio data is the best among the kinds of mute processing.

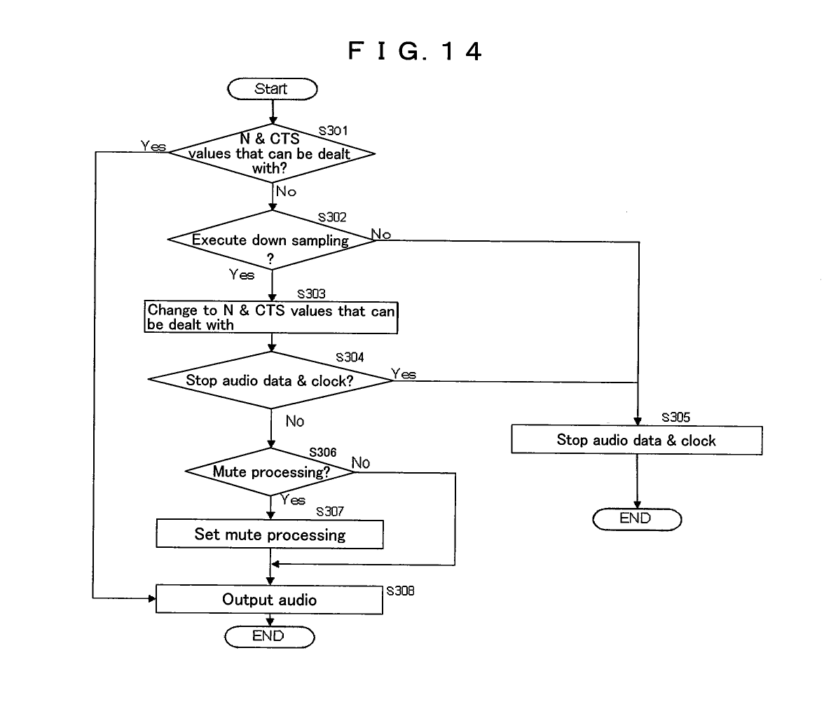

FIG. 14 is a flowchart for showing the overall flow of the down sampling processing executed on the video/audio data receiving device 200 side among the processing of the digital transmission system and the clock generating device. First, it is judged whether or not the frequency dividing information N and the time information CTS received at the video/audio data receiving device 200 can be dealt with by the audio sampling frequency Fs that can be set in the video/audio data receiving device 200 (S301). When judged in S301 that the frequency dividing information N and the time information CTS are applicable, the procedure is shifted to the audio output processing (S308) without performing the down sampling processing. On the other hand, when judged in S301 that the frequency dividing information N and the time information CTS are not applicable, it is then judged whether or not the down sampling processing control is executed (S302). When judged in S302 that the down sampling control is executed, the frequency dividing information N and the time information CTS received at the video/audio data receiving device 200 are changed to the values that can be dealt with by the audio sampling frequency Fs that can be set in the video/audio data receiving device 200 (S303).

After the processing of S303 is performed, it is judged whether or not the audio data and the clock are stopped (S304). When judged in S304 that the audio data and the clock are stopped, the output of the audio data and the output of the clock are stopped (S305). When judged in S304 that the audio data and the clock are not stopped, it is then judged whether or not to perform the mute processing (S306). When judged in S306 that the mute processing is performed, the mute setting processing is executed (S307). Then, the procedure is shifted to the audio output processing S308. On the other hand, when judged in the processing of S306 that the mute processing is not performed, the procedure is shifted to the audio output processing (S308) without shifting to the mute setting processing (S307).

For the video/audio data receiving device 200, the best mode is a method of executing the mute processing after execution of the down sampling processing. The reasons for this are as follows. That is, when the audio data and the clock are stopped, a possibility occurs that the clock does not reach the audio I/F 213 and thus, the video/audio data receiving device 200 may not be able to recognize the audio data properly. Further, if the mute processing after execution of the down sampling is not performed, there is a possibility of generating a strange sound. Because of these reasons, it can be said that the method of executing the mute processing after execution of the down sampling is the best mode for the video/audio data receiving device 200.

Through the above, it becomes possible with the present invention to transmit the frequency dividing information N and the time information CTS by changing those on the video/audio data transmitting device 100 into the values that can be received at the video/audio data receiving device 200. Further, it is also possible on the video/audio data receiver side to change the audio data to the receivable data. Therefore, the present invention can provide processing methods of a digital transmission system and a clock generating device which can transmit the data to various kinds of video/audio data receiving devices 200.

The present invention has been described in detail by referring to the most preferred embodiments. However, various combinations and modifications of the components are possible without departing from the spirit and the broad scope of the appended claims.

What is claimed is:

1. An audio data transmitting device, comprising:
an input device to which audio data is inputted;
an information obtaining device for obtaining information regarding its audio data processing capacity from an audio data receiving device that is a transmission source of said audio data that is inputted to said input device;
an analyzer for analyzing said information obtained by said information obtaining device;
an information adder which generates header information of said audio data suited for said audio data receiving device based on a result of analysis executed by said analyzer, and then adds said header information generated thereby to said audio data that is inputted to said input device;
an information packet generator for generating an audio clock information packet that corresponds to said audio data inputted to said input device; and
and an output device for outputting, to said audio data receiving device, superimposed data that is obtained by superimposing said audio clock information packet on said audio data to which said header information is added.

2. The audio data transmitting device according to claim 1, further comprising a changing device which changes a sampling frequency that is set in said audio data inputted to said input device into a sampling frequency suited for said data receiving device.

3. The audio data transmitting device according to claim 2, wherein said output device is capable of limiting a signal level of audio data to be outputted.

4. The audio data transmitting device according to claim 2, wherein said input device is capable of inputting compressed audio data and uncompressed audio data as said audio data.

5. The audio data transmitting device according to claim 4, wherein:
said compressed data is audio data of IEC50958/61937 standard; and
said uncompressed data is audio data that conforms to IEC60958 standard, I2S, and a left-justified or right-justified format.

6. The audio data transmitting device according to claim 1, wherein said output device is capable of stopping output of said audio clock information packet and said audio data.

7. The audio data transmitting device according to claim 1, wherein said output device is capable of stopping output of said audio data.

8. The audio data transmitting device according to claim 6, wherein said output device is capable of stopping output of said audio clock information packet and said audio data simultaneously.

9. A video/audio output unit, which is capable of stopping audio data only, in said audio data transmitting device of claim 1.

10. An audio data receiving device, comprising:
an input device to which superimposed data constituted with audio data and audio clock information packet is inputted;
an analyzer which extracts said audio data from said superimposed data that is inputted to said input device, and analyzes header information thereof;
a reproduction clock generator which extracts said audio clock information packet from said superimposed data that is inputted to said input device, and generates a reproduction clock based on said audio clock information packet; and
an output device for outputting said reproduction clock, said audio data, and a video data.

11. The audio data receiving device according to claim 10, further comprising a changing device which changes a sampling frequency that is set in said audio data inputted to said input device into a sampling frequency suited for said data receiving device.

12. The audio data receiving device according to claim 10, wherein said output device is capable of limiting an output level of audio data to be outputted.
